(19) United States
(12) Patent Application Publication
(10) Pub. No.: US 2026/0038012 A1
(43) Pub. Date: Feb. 5, 2026

(54) SYSTEMS AND METHODS FOR LINKING PRODUCT DATA FROM MULTIPLE CHANNELS OF ONLINE MARKETPLACES

(71) Applicant: Quartile Digital, Inc., New York, NY (US)

(72) Inventors: Daniel Knijnik, Riverside, CT (US); Anibal Knijnik, Aventura, FL (US); Alexandre Dorbleo Ely, Botucatu (BR); Rodrigo Fraga Mohr, Porto Alegre (BR); Solano Pertile Campos, Porto Alegre (BR)

(21) Appl. No.: 19/284,951

(22) Filed: Jul. 30, 2025

Related U.S. Application Data
(60) Provisional application No. 63/677,181, filed on Jul. 30, 2024.

(51) Int. Cl. G06Q 30/0601

(52) U.S. Cl. CPC G06Q 30/0601

(57) ABSTRACT

A method and associated system for linking product data from multiple channels of online marketplaces, the method including a) providing at least one first parameter associated with a product, b) generating a primary table based on the at least one first parameter, c) determining at least one first value associated with the at least one first parameter, d) obtaining data associated with the product from multiple channels of online marketplaces, e) transforming the data into a unified format, where the transformed data includes at least one second value, f) automatically generating an updated primary table based on the primary table, the at least one first value, and the transformed data including the at least one second value in an iterative or recursive manner, and g) continuously replacing the primary table with the updated primary table in an iterative or recursive manner through repeating steps (d)-(f).

### CROSS-REFERENCE TO RELATED APPLICATIONS

The present application claims priority to U.S. Provisional Application No. 63/677,181, filed Jul. 30, 2024, the disclosures and teachings of which are incorporated herein by reference.

### TECHNICAL FIELD

The present invention relates to systems and methods to improve data gathering of sales and advertising information of a given product, or family of products, in an e-commerce environment, particularly systems and methods for linking product data from multiple channels of online marketplaces.

### BACKGROUND OF THE INVENTION

As e-commerce sellers increasingly use multiple sales channels, it is vital for them to base their marketing and commercial decisions on comparing the effectiveness of each channel and, for that task, they need a tool to consolidate and compare, in a systematic, quick, unified, and reliable manner, information gathered across all channels around the same time. Many of these sellers hire Digital Marketing Companies (DMCs) to help with such multi-channel marketing. As these DMCs continue to work with more multi-channel clients, it becomes increasingly important for them to be able to offer a cross-channel solution for their clients that links their products across AMAZON, GOOGLE, and other core channels. Right now, however, these clients can only look at reporting, specifically concerning product performance, for each channel independently. By creating a database that links products together while using different product identification protocols as needed across different channels, a DMC can offer more insightful and automated cross-channel reporting at the product level, allowing their clients to quickly start using this data to make commercial and marketing decisions. The ready availability of such data is the foundation on which additional cross-channel campaign management features may be built.

Generally, prior art methods and systems only provide this data on an individual basis, retrieving commercial and advertising data from each channel separately, and indexing the data by advertising campaign.

Currently available cross-channel data retrieving methods and systems must deal with the stringent data allowances particular to each channel. These restrictions result in the consolidation of the retrieved data being slow and untimely with such consolidation being done in a segmented manner. This consolidation must also consider the diversity of retrieving times, dates, limits, and capacities of each channel, in addition to the possibility of more than one campaign being launched for the same product on the same channel.

Different channels require different advertising strategies, so that the same product almost always will demand different ad campaigns among the channels. If a seller has a small number of products being offered on various channels, it is possible, albeit time-demanding, for him to manage the advertising decisions in the various channels. However, if the number of products is large, for example, in the hundreds or thousands, then optimizing the division of the seller's advertising budget between the channels is almost impossible to do in a timely way by itself. Even with the help of currently available software, such optimization is almost impossible, as the availability of commercial data (e.g., units sold, ad spend, etc.) from each of the various channels is disparate. For instance, the same product, pet stairs, can be advertised by the seller in one channel as “rugged pet stair” and in another channel as “sturdy pet stair,” making it cumbersome to consolidate the number of pet stairs sold and the ad spend per sale in every channel.

Adding another layer of difficulty to the task of timely consolidation of sales and advertising throughout different channels is the fact that there is no universally accepted protocol of identification of the products being advertised. For instance, AMAZON uses the AMAZON Standard Identification Number (ASIN), GOOGLE uses the Global Trade Item Number (GTIN), INSTACART uses the Universal Product Code (UPC), while still other channels use the European Article Number (EAN), the International Standard Book Number (ISBN), the Japanese Article Number (JAN), the Medical Instrument Standardized Article Number (MINSAN), or the Stock Keeping Unit (SKU), among other identification protocols.

There is a need in the art for an efficient automated tool that merges data for the same product from different channels for each advertiser such that companies are empowered to make timely decisions based on actual data for every product being advertised throughout all the companies' channels of interest. Such a tool would allow these companies to gain a competitive advantage in the marketplace.

The present invention solves the problems of the prior art by providing systems and methods for the timely consolidation of commercial data already gathered via an application programming interface (API) from all channels of interest of the advertiser/seller. The present invention provides systems and methods that retrieve data from multiple channels already segmented by product according to a proprietary system that stores each piece of retrieved data in a unique database containing all products whose advertising campaigns are managed by the DMC separated by channel and advertiser. Besides grouping all the retrieved data of a given product as collected through a cross-channel retrieval API, the present invention makes it possible to present the data in a dashboard. The dashboard enables the seller to easily understand and evaluate the effectiveness of the ad spending in each channel, allowing the seller to decide how to divide the advertising budget between the many available channels to optimize its commercial goals.

### SUMMARY OF THE INVENTION

In general, in one aspect, the invention features a method for linking product data from multiple channels of online marketplaces, the method including, under control of one or more processors configured with executable instructions, a) providing at least one first parameter associated with a product, b) generating a primary table based on the at least one first parameter, c) determining at least one first value associated with the at least one first parameter, d) obtaining data associated with the product from multiple channels of online marketplaces, e) transforming the data into a unified format, where the transformed data includes at least one second value, f) automatically generating an updated primary table based on the primary table, the at least one first value, and the transformed data including the at least one second value in an iterative or recursive manner, and g) continuously replacing the primary table with the updated primary table in an iterative or recursive manner through repeating steps (d)-(f).

Implementations of the invention may include one or more of the following features. The step of generating the updated primary table may further include at least one of the followings steps: matching the at least one first value to the at least one second value, adding at least one second parameter to the primary table based on the at least one second value, deleting the at least one first parameter from the primary table based on the at least one second value, or modifying the at least one first parameter based on the at least one value of the transformed data. The step of obtaining data associated with the product may include obtaining the data from the multiple channels of online marketplaces through an application programming interface call. The step of transforming the data into a unified format may include transforming the data from an unprocessed state into an input table, with the input table including the at least one second value.

Each of the at least one first value and the at least one second value may include at least one parameter type, the at least one parameter type including at least one of a product identifier, a product channel identifier, and a product activity indicator. The product identifier may include at least one of a channel product identifier, a product title, a product image, and a global identifier. The product identifier may be at least one of a global trade item number (GTIN), an AMAZON standard identification number (ASIN), a universal product code (UPC), a European article number (EAN), an international standard book number (ISBN), a Japanese article number (JAN), a medical instrument standardized article number (MINSAN), and a stock keeping unit (SKU). The step of transforming the data from the unprocessed state into the input table may include determining a parameter type of the data and assigning the determined parameter type to the at least one second value.

In general, in another aspect, the invention features a system for linking product data from multiple channels of online marketplaces, the system including one or more processors, one or more computer-readable media, and one or more modules maintained on the one or more computer-readable media that, when executed by the one or more processors, cause the one or more processors to perform operations including a) providing at least one first parameter associated with a product, b) generating a primary table based on the at least one first parameter, c) determining at least one first value associated with the at least one first parameter, d) obtaining data associated with the product from multiple channels of online marketplaces, e) transforming the data into a unified format, where the transformed data includes at least one second value, f) automatically generating an updated primary table based on the primary table, the at least one first value, and the transformed data including the at least one second value in an iterative or recursive manner, and g) continuously replacing the primary table with the updated primary table in an iterative or recursive manner through repeating steps (d)-(f).

Implementations of the invention may include one or more of the following features. The updated primary table may be generated by at least one of matching the at least one first value to the at least one second value, adding at least one second parameter to the primary table based on the at least one second value, deleting the at least one first parameter from the primary table based on the at least one second value, or modifying the at least one first parameter based on the at least one value of the transformed data. The data associated with the product may be obtained from the multiple channels of online marketplaces through an application programming interface call. The data may be transformed into a unified format by transforming the data from an unprocessed state into an input table, with the input table including the at least one second value.

Each of the at least one first value and the at least one second value may include at least one parameter type, the at least one parameter type including at least one of a product identifier, a product channel identifier, and a product activity indicator. The product identifier may include at least one of a channel product identifier, a product title, a product image, and a global identifier. The product identifier may be at least one of a global trade item number (GTIN), an AMAZON standard identification number (ASIN), a universal product code (UPC), a European article number (EAN), an international standard book number (ISBN), a Japanese article number (JAN), a medical instrument standardized article number (MINSAN), and a stock keeping unit (SKU). The step of transforming the data from the unprocessed state into the input table may include determining a parameter type of the data and assigning the determined parameter type to the at least one second value.

In general, in another aspect, the invention features a method for linking product data from multiple channels of online marketplaces, the method including, under control of one or more processors configured with executable instructions, a) providing a plurality of parameters associated with at least one product, the plurality of parameters including at least one product identifier and at least one client identifier, b) generating a primary table based on the plurality of parameters, c) mapping the plurality of parameters based on the primary table, such that each at least one product identifier is associated with at least one client identifier, d) determining at least one first value associated with each of the plurality of parameters, e) obtaining raw data associated with the product from multiple channels of online marketplaces, f) transforming the raw data into an input table, where the input table includes at least one second value, g) automatically generating an updated primary table based on the primary table and the input table in an iterative or recursive manner by 1) comparing the at least one second value with the at least one first value, 2) determining whether the at least one second value supersedes the at least one first value, 3) discarding the at least one second value when the at least one second value matches the at least one first value, 4) replacing the at least one first value with the at least one second value when the at least one second value is determined to supersede the at least one first value, and 5) appending the at least one second value to the primary table when the at least one second value does not match or supersede the at least one first value, and h) continuously replacing the primary table with the updated primary table in an iterative or recursive manner through repeating steps (e)-(g).

Implementations of the invention may include one or more of the following features. The step of transforming the raw data into an input table may include normalizing the data into the at least one second value.

### BRIEF DESCRIPTION OF THE DRAWINGS

FIG. 1 shows a schematic representation of the partial gathering of commercial data according to an embodiment of the present invention;

FIG. 2 shows a flowchart of an update of existent data tables according to an embodiment of the present invention;

FIG. 3 shows a flowchart of an updating process according to an embodiment of the present invention;

FIG. 4 shows an exemplary group of channels used to compare and consolidate data regarding a product according to an embodiment of the present invention;

FIG. 5 shows another exemplary group of channels used to compare and consolidate data regarding a product according to an embodiment of the present invention;

FIG. 6 shows a representation of an exemplary group within software used in a system according to an embodiment of the present invention;

FIG. 7 shows a table with exemplary Global Identifiers used by different channels according to an embodiment of the present invention;

FIG. 8 shows a portion of an Input Table according to an embodiment of the present invention;

FIG. 9 shows a first step in screening retrieved data, after a reading of the Input Table, according to an embodiment of the present invention;

FIG. 10 shows the first step in screening retrieved data, after the reading of the Input Table, with a new product appended thereto, according to an embodiment of the present invention;

FIG. 11 shows a populated table for two different TenantIds and three Linked Channels according to an embodiment of the present invention;

FIG. 12 shows an enlarged upper portion of the table shown in FIG. 11;

FIG. 13 shows an enlarged lower portion of the table shown in FIG. 11;

FIG. 14 shows a populated table for two different TenantIds and three Linked Channels, including a system generated temporary solution for a Global Identifier, according to an embodiment of the present invention;

FIG. 15 shows an enlarged upper portion of the table shown in FIG. 14;

FIG. 16 shows an enlarged middle portion of the table shown in FIG. 14, highlighting a system generated solution to the absence of a Global Identifier;

FIG. 17 shows an enlarged lower portion of the table shown in FIG. 14;

FIG. 18 shows an output table after a mapping of paired Global Identifier and DMC IDs according to an embodiment of the present invention;

FIG. 19 shows a flowchart of one TenantId, with two LinkedChannelIds, and multiple products according to an embodiment of the present invention;

FIG. 20 shows an exemplary product that a company may list on multiple channels;

FIG. 21 shows a picture of the product listing from which data may be retrieved according to an embodiment of the present invention;

FIG. 22 shows a consolidation of data retrieved for a group of products in three different marketplaces in a given week in accordance with an embodiment of the present invention;

FIG. 23 shows a consolidation of data retrieved for a group of products 7 days after the consolidation shown in FIG. 22 in the same three different marketplaces, in accordance with an embodiment of the present invention;

FIG. 24 shows a dashboard summary including Identifiers for a single product listed on different marketplaces and consolidated according to an embodiment of the present invention;

FIG. 25 shows an exemplary product and associated link in connection with a first marketplace;

FIG. 26 shows the exemplary product of FIG. 25 and an associated link in connection with a second marketplace; and

FIG. 27 shows Identifiers for the exemplary product of FIGS. 25-26 from an exemplary DMC and subset of marketplaces according to an embodiment of the present invention.

### DETAILED DESCRIPTION OF THE INVENTION

Clients of a DMC usually advertise and sell their products on multiple channels (AMAZON, WALMART, SHOPIFY, etc.). Almost all of their products can and likely will be offered to sell on different marketplaces at the same time, sometimes with different labels. The managing of such data is difficult, cumbersome, and time-consuming. The commercial data must be retrieved from the marketplaces via an API, according to their rules, limits, and frequencies, and consolidated to give the seller the ability to make informed decisions on how to deal with advertising budget, inventory management and pricing strategies.

One of the main goals of the present invention is to make this cross-channel retrieval of commercial data readily available to advertisers and/or sellers, so that they can easily consolidate overall selling of every product over the various marketplaces they work with and compare the effectiveness of each marketplace or channel in terms of spent advertising.

The core innovation of this method is the capacity to merge in one single table all product tables from all channels for a given advertiser, combining all information and normalizing column names. No conventional software can retrieve commercial data for all products in as many channels as desired, for every single advertiser or seller, in a fast and reliable way.

Additionally, one must bear in mind that all products sold by the marketplaces must have a Global Identifier. A Global Identifier of a product in e-commerce is a unique code assigned to each product that ensures it can be universally recognized and tracked across different platforms, marketplaces, and systems. This Identifier typically includes standardized codes, such as the GTIN, UPC, EAN, and ISBN. Any Global Identifier is univocally linked to one and only one product, but the reciprocal is not true as the same product can have several Global Identifiers. For instance, an exemplary product: 4 INCH GUTTERBRUSH GUARD—24 FT. (shown in FIG. 20) has the following Global Identifiers in three different marketplaces:
A. In GOOGLE:
Title: 4 Inch Gutter Guards|24 Ft
Google Product Id: 42148967383133
Global Identifiers:

[{“Identifier_Type”:“GTIN”,“Value”:“854371001193”},{“Ide
ntifier_Type”:“Barcode”,“Value”:“854371001193”}]

B. In AMAZON:
Title: Gutter Guard for Small Gutters—Patio Rooms,
Awnings, Carports, Trailer Homes—by GutterBrush
Amazon Product Id: B0CHWM9WF9
Global Identifiers:

[{“Identifier_Type”:“EAN”,“Value”:“0854371001193”},{“Ide
ntifier_Type”:“UPC”,“Value”:“854371001193”}]

C. In SHOPIFY:
Title: 4 INCH GUTTER GUARD—24 FT. (3.25 IN. DIA.)
Default Title
Shopify Product Id: 6345191684
Global Identifiers:

[{“Identifier_Type”:“Barcode”,“Value”:“00854371001193”},
{“Identifier_Type”:“GTIN”,“Value”:“00854371001193”}]

To start the process of the present invention, a DMC creates a table with significant parameters of all the products advertised by their clients. The initially chosen significant parameters can be amended whenever the DMC wants. In one embodiment of the present invention, the initial significant parameters are as follows:
TenantId, a client identifier within the DMC system;
AdvertiserId, a client identifier within a channel's system;
LinkedChannelId, a logical grouping, manually created in the DMC system, which allows the client to associate accounts from two or more different channels for the same ProductId;
Channel, a name of a channel;
Channel_ProductId, an ID of the product inside a channel;
Product_Title, a title of the product, which can be simple with no need to be the full description of the product;
Product_Image_Link, a direct internet link to an image of the product, not to a website on which the image is displayed;
LastUpdateTime, a last time when the product was modified, normally provided by a channel but, if not, provided by the DMC;
IsActive, a Boolean indicator showing whether the product is active on a channel or has been turned off; and
Global_Identifiers, a structured list containing information on the type of identifier (e.g., GTIN, EAN, UPC, etc.), labeled as Identifier_Type, and the number associated with the identifier, labeled as Value, which is compiled from separate columns available in each channel's Product Table.
   Of these parameters, the Global_Identifiers parameter is a key parameter for the system and method of the present invention. While the Identifier_Type information is only a name to be used in the visualization provided to the advertisers/sellers, the Value information is key to the operation of the present invention. Global Identifiers are a characteristic of the product, being informed by the seller according to international protocols. The Value information in the Global Identifiers parameter allows the systems and methods of the present invention to accurately identify, organize, and consolidate particular products across multiple channels and advertising campaigns.

This table created by the DMC is called the Primary Table, as it is the starting point to the continuous update process. In one embodiment of the process, the Primary Table is called Silver Table. In the Primary Table, all products, advertised in the multiple channels, are listed, and stored under a unique proprietary DMC Identifier. The unique DMC Identifier (DMC-I) encompasses all the distinct entries chosen by the DMC for the same product and the same advertiser/seller across all channels. This means that the same product can and likely will be identified by several entries under the same DMC-I, each composed of its respective pair of values (Global Identifier, channel). The DMC-I relates to both the channel and the product for the same advertiser, as different channels may have different identifiers for the same product, and the same product can have a different DMC-I on different channels, e.g., one for each advertiser/client. The Primary Table incorporates all products that have been managed by the DMC across all channels at least once. It is important to note that any DMC-I consolidates, for every advertiser, every Identifier for each product. All Global Identifiers for the same product in the same channel may be stored under only one DMC-I in the Primary Table of the DMC. In one embodiment of the present invention, the number of stored DMC-Is is in the millions. In one embodiment of the present invention, the DMC-I is called Quartile_ProductId.

Once the first Primary Table is created and stored in a database of the DMC, the process begins to update the Primary Table by cyclically retrieving values and data from the various channels and adding to or modifying the Primary Table as needed with the retrieved values. The frequency of these updates can be made at the DMC's will, respecting the channels' rules and the DMC's internal protocols and workflows. In one embodiment of the present invention, this first Primary Table is called the Silver Table and is updated daily.

The update process starts by reading all entries in the most recent Primary Table. This reading allows future entries to be sent to the right destination or be discarded when there is already the same product listed on the Primary Table of the DMC for the chosen advertiser. The reading may also allow a new future entry to be used to create a new entry on the Primary Table to encompass all the proprieties of the pair new product and channel for the corresponding advertiser.

To update the Primary Table with the most recent retrieved data from all channels, the DMC populates an Income Table, with data from various channels (such as AMAZON, GOOGLE, BING, FACEBOOK, among others). Once the data is captured via APIs, it is transformed into structured tables encompassing all the relevant information, as defined by the DMC, and stored in its database. This Income Table serves as the repository for raw retrieved data, as collected and in diverse formats. This Table is subsequently harmonized into a unified format, tailored for enterprise-wide accessibility. The Income Table additionally ensures data integrity by providing suitable backup capabilities. In one embodiment of the present invention, the Income Table is called the Bronze Table.

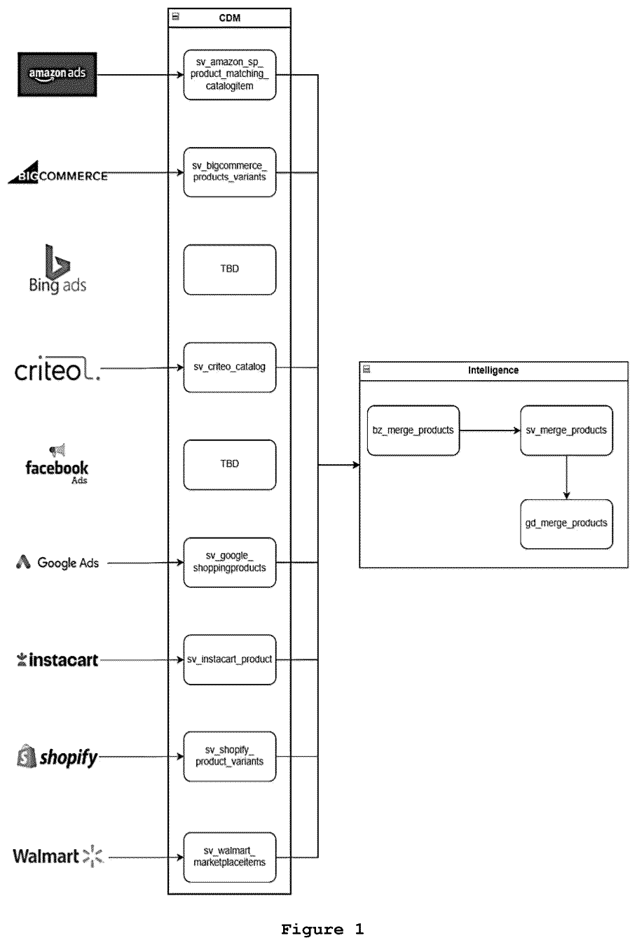

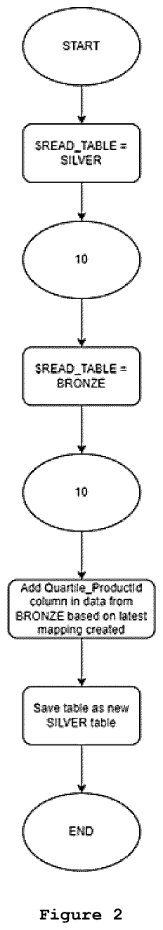

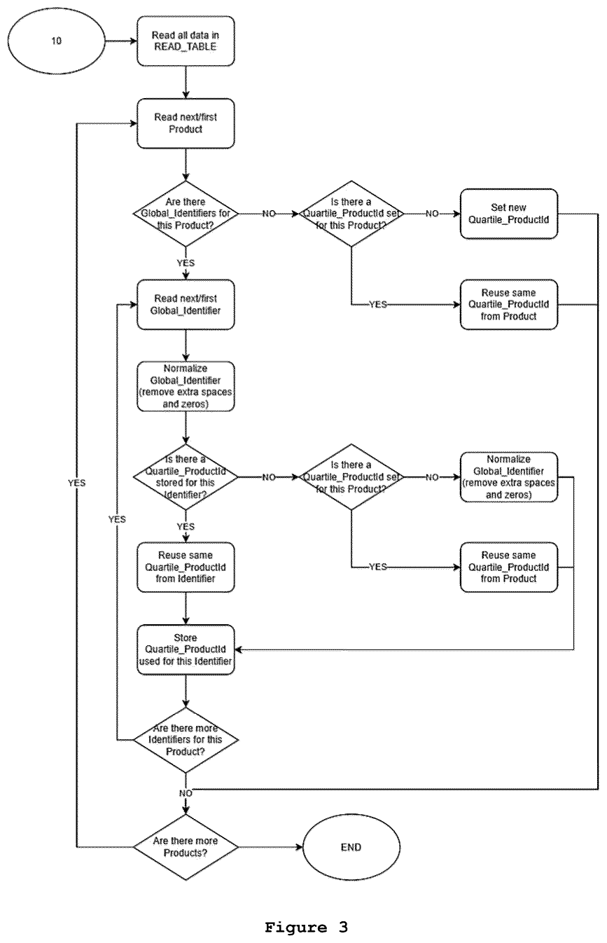

FIG. 1, FIG. 2, and FIG. 3 provide a flowchart of the updating process, using the cited nomenclature of one embodiment of the present invention. The flowchart in FIG. 1 shows a partial gathering of commercial data from the included channels using the respective channel APIs and the storage of the commercial data in the Input Table and Initial Tables. FIG. 2 shows an overall updating process for existing tables, while FIG. 3 shows an in-depth updating procedure performed in step 10 of of FIG. 2.

With reference to FIGS. 2 and 3, the process starts by reading the most recent Primary Table (Silver Table in the exemplary embodiment) stored in the DMC's database. In sequence, after the reading is finished, the Income Table (Bronze Table in the exemplary embodiment) is populated, and the reading and comparison of the two tables starts.

For every entry in the Income Table, software of the system of the present invention determines if there is already a Global Identifier for the product. If a Global Identifier for the product exists, then the software determines if there is already a DMC-I in the DMC's database. If the Global Identifier for the product matches one already stored under any DMC-I in the Income Table, the software uses the stored DMC-I for the product and reads the next entry in the Income Table. This process is repeated until the last product on the Income Table is read. If the match is not found, the software creates a new DMC-I for the product, as this constitutes a new product, and stores the new DMC-I in the DMC's database after normalizing the product's Global Identifier. The normalization may be performed, for example, by suppressing any extra spaces and/or extra zeros in the Global Identifier.

Storing all Global Identifiers for the same product across all channels in a single DMC-I (Quartile_ProductId in a preferred embodiment of this invention) provides a quick and reliable way to consolidate all of the commercial data for any product.

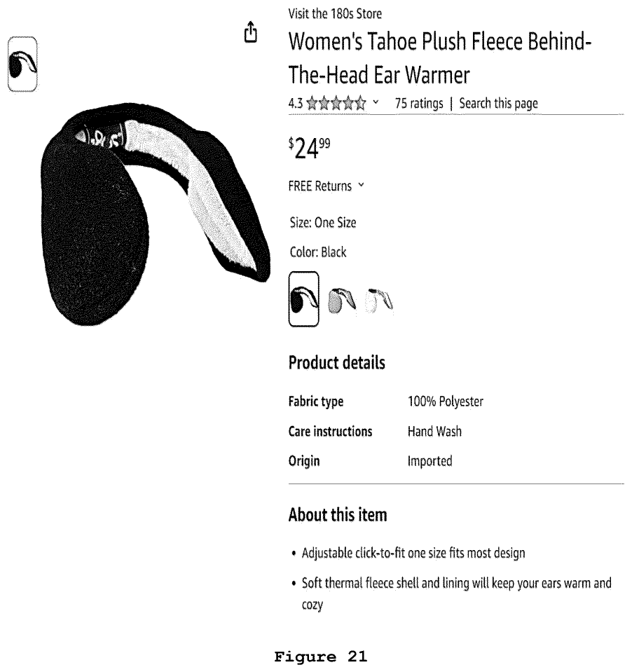

If a product does not have a Global Identifier, the software may create a temporary DMC-I by adding the name of the channel to the index used by the channel to identify the product, for example, Amazon_B00LY1Z144 (shown in FIG. 21).

Once the product is identified by the system as matching an existing DMC-I, the temporary DMC-I is disabled, and data associated with the temporary DMC-I is transferred automatically to the matching DMC-I.

In summary, one object of the invention is to provide a systematic procedure designed to generate a new Primary Table from the existing data in the Input Table and previous Primary Tables. An exemplary embodiment of the method of the present invention is as follows:
1. Examine the Primary Table: The Primary Table is a comprehensive database that contains detailed information about a majority of the products. The first step of the algorithm involves a thorough examination of this table.
2. Create a mapping: After examination, a mapping is created. This mapping establishes a connection between each Global Identifier (a unique identification code assigned to each product) and its corresponding DMC-I (a proprietary identification system used internally for each product). In some embodiments, the format for this mapping includes taking the client identifier within the DMC system, the TenantID, plus the grouping associating two or more different channels for the same ProductId, the LinkedChannelID, associating those with a Global Identifier Value, and further associating those with a DMC-I. Accordingly, this mapping serves as an index, providing quick and easy access to the information for each product.
3. Process new data from the Input Table: The Input Table contains fresh data or new entries related to products that have not been incorporated into the Primary Table yet. Using the mapping created earlier, the system and method of the present invention efficiently locate where each new product entry should be placed in the Primary Table. In certain embodiments, the new product entries already have an assigned place in the mapping, and the system discards the duplicate data. However, where new product entries do not have an assigned place in the mapping, the new product entries are added to the mapping in accord with step 2.
4. Append new data to existing dictionaries: The new product entries from the Input Table are then appended to the existing Primary Table, thereby generating a new Primary Table.
5. Join the final mapping with the Input Table: The final step involves joining the updated mapping with the Input Table. The old Primary Table is replaced with the new Primary Table. The systems and methods of the present invention thus ensure the Primary Table is always up-to-date, accurately reflecting the most recent product data from the Input Table and the existing data in the previous version of the Primary Table.

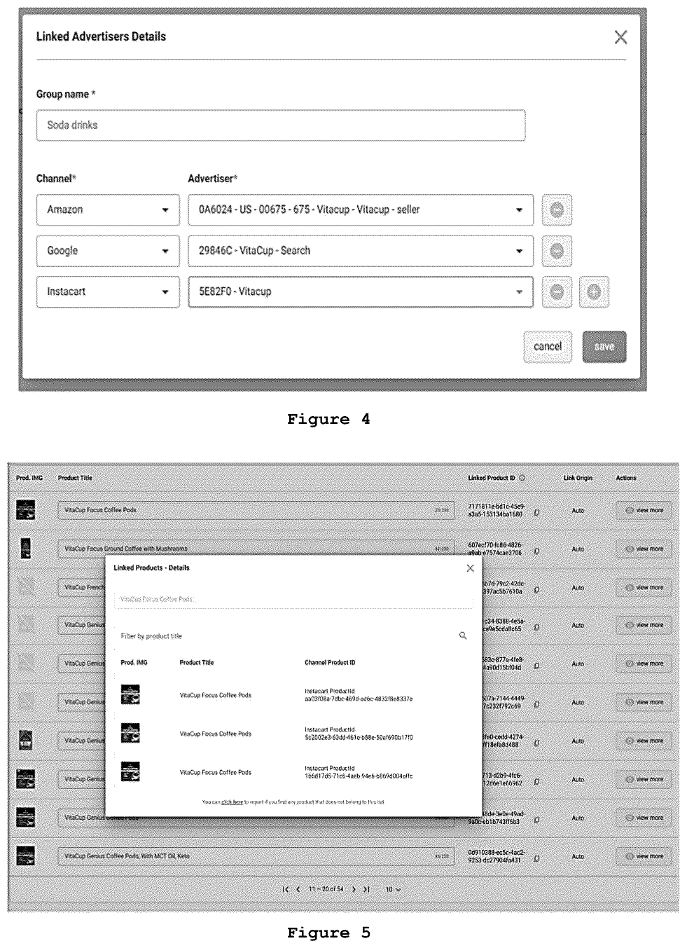

FIGS. 4 and 5 show exemplary groups of different channels used to compare and consolidate data regarding products. Such groups are labeled LinkedChannelId by the system of the present invention. The group of included products may be chosen by the seller or advertiser at its discretion.

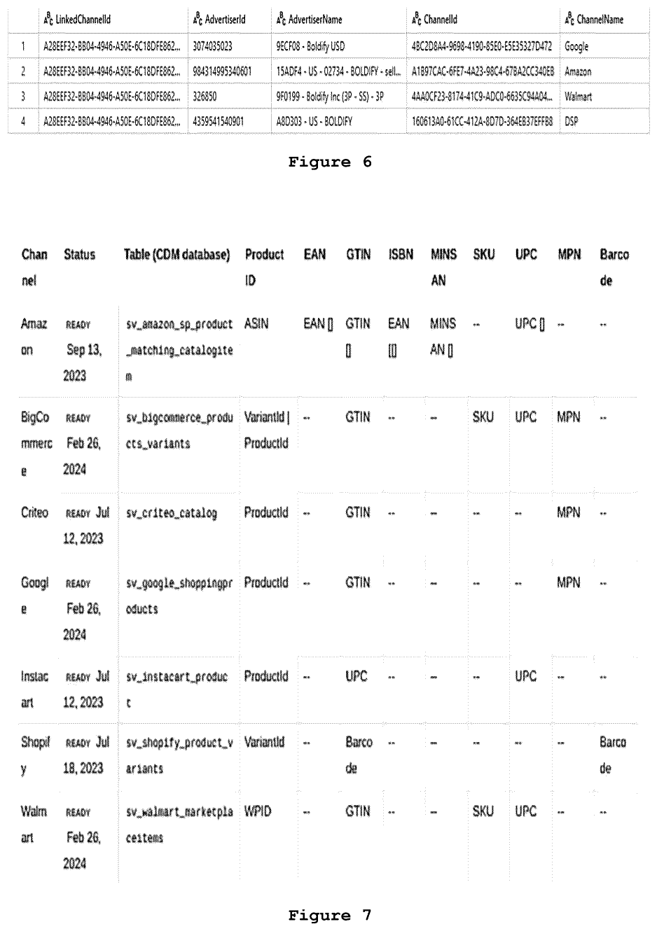

FIG. 6 shows an exemplary representation of the LinkedChannelId used in the software of the system of the present invention. The channels' names are not used. Instead, the software generates a variable and substitutes the variable in place of the channels' name. This eliminates the chance that a channel's name is incorrectly mapped due to a misspelling when entered in the system.

FIG. 7 shows a table with exemplary Global Identifiers used by different channels that may be included in the system of the present invention.

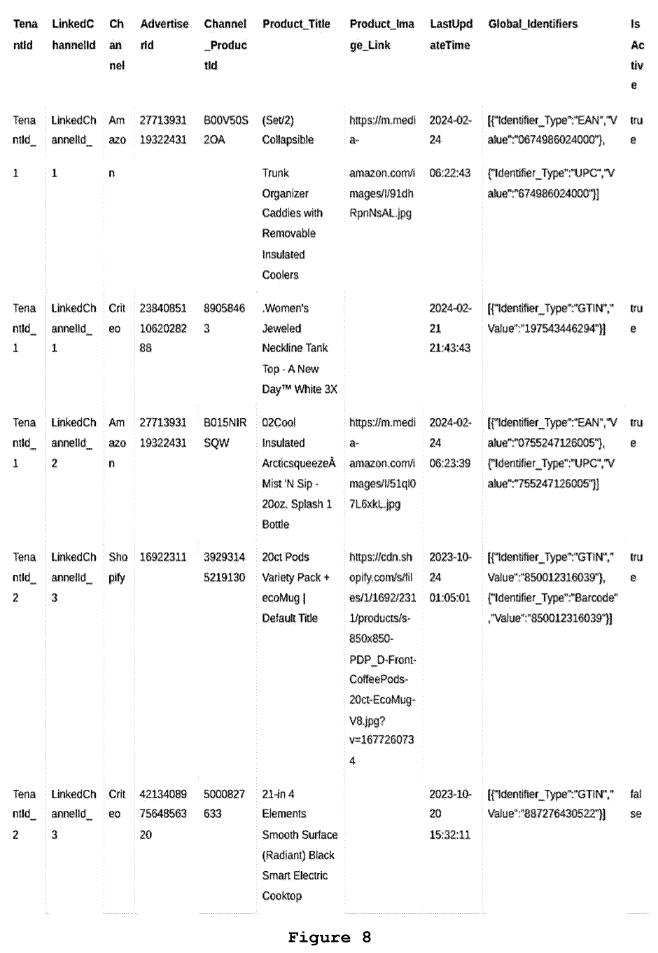

FIG. 8 shows an exemplary Input Table used in the system of the present invention, showing chosen parameters and corresponding data for each chosen parameter.

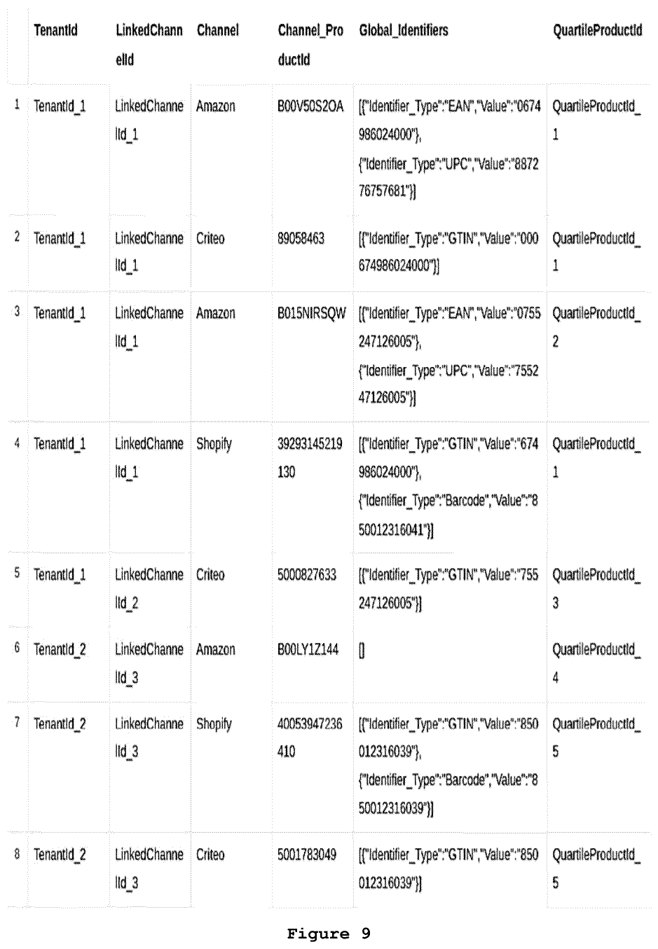

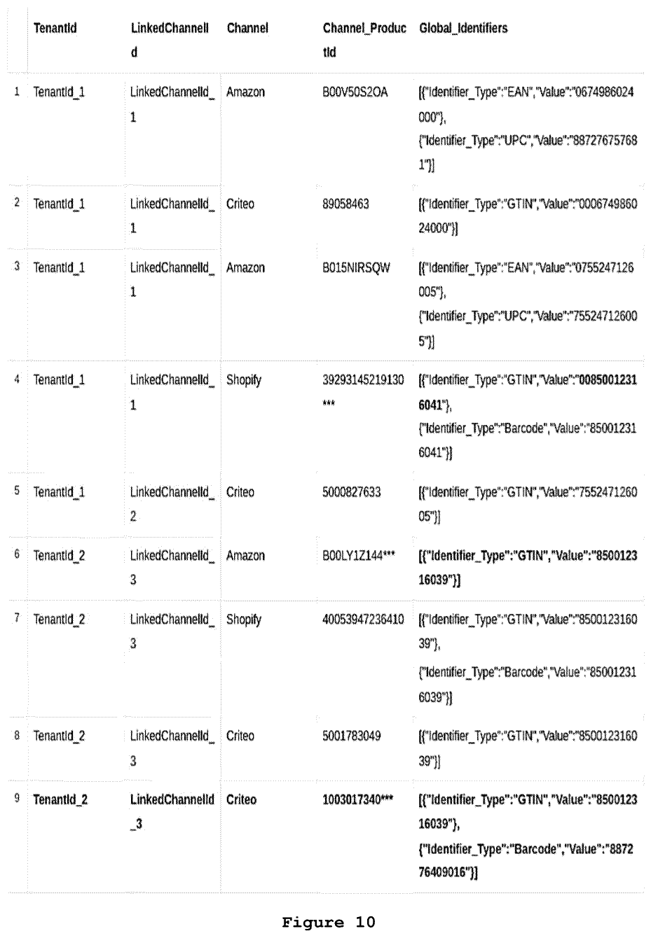

FIGS. 9 and 10 show an embodiment of a first step in the screening of the retrieved data by the system, after the system has read the Input Table. FIG. 10 further shows an embodiment of the system appending data for a new product entry to the Input Table.

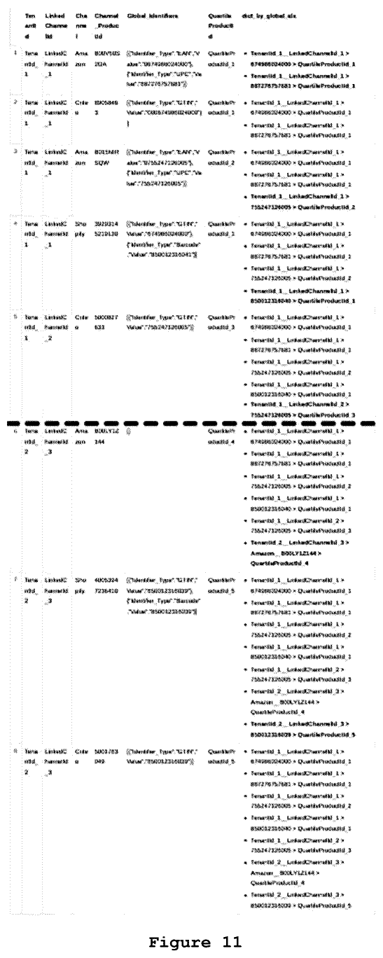

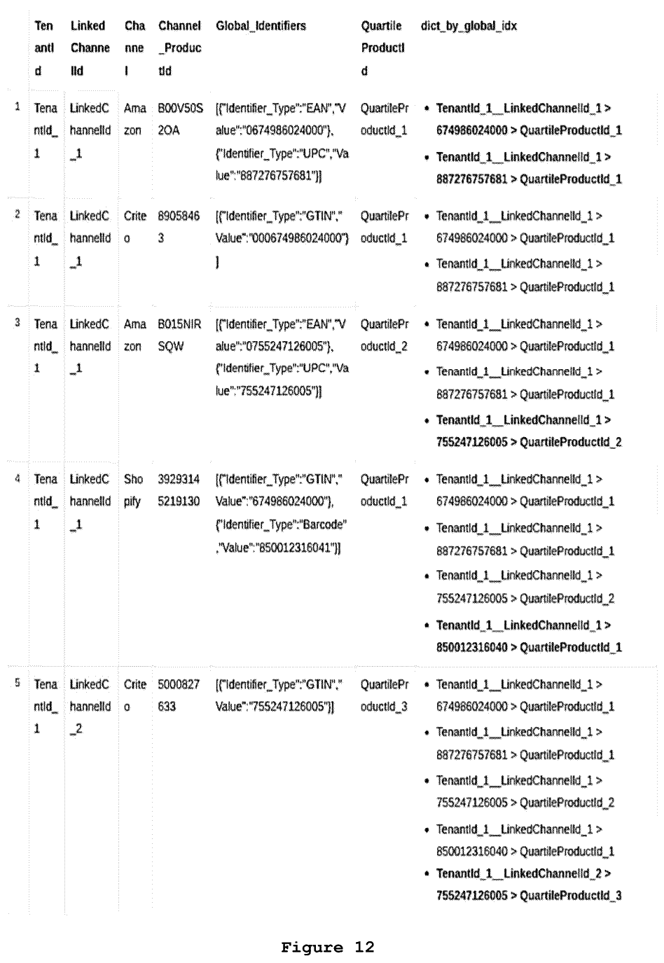

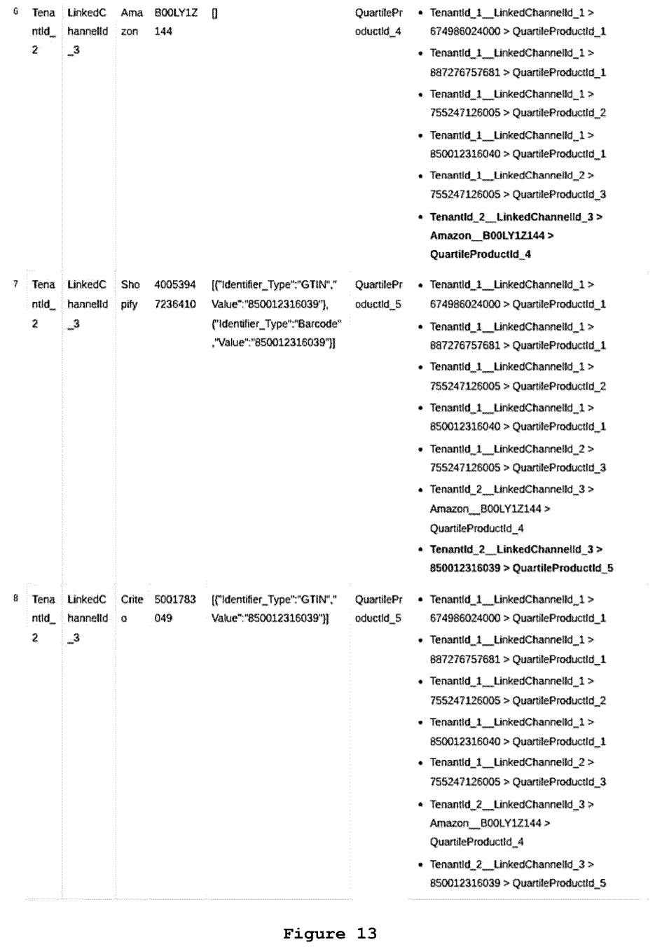

FIGS. 11-13 show an embodiment of a completely populated Primary Table for two different TenantIds and three Linked Channels. As best seen in FIGS. 11 and 13, a product without a Global Identifier appears in line 6 of the Input Table.

FIG. 13 further shows how the system creates a temporary Global Identifier, shown in bold, for the product such that the system may continue to map the data to the Primary Table.

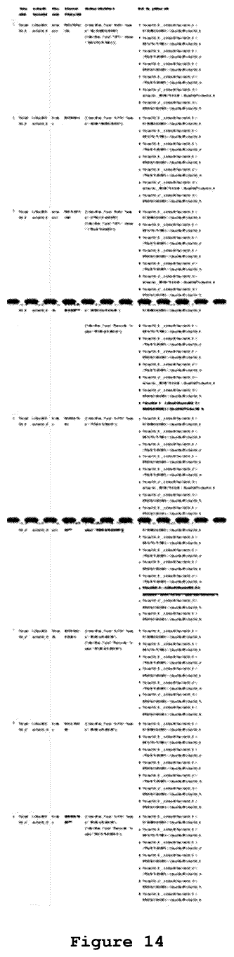

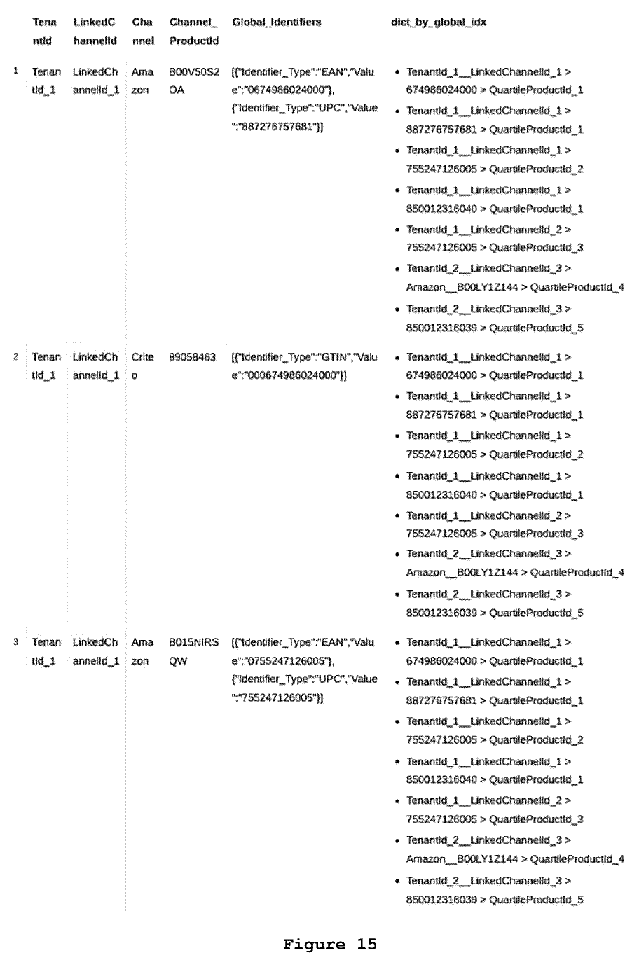

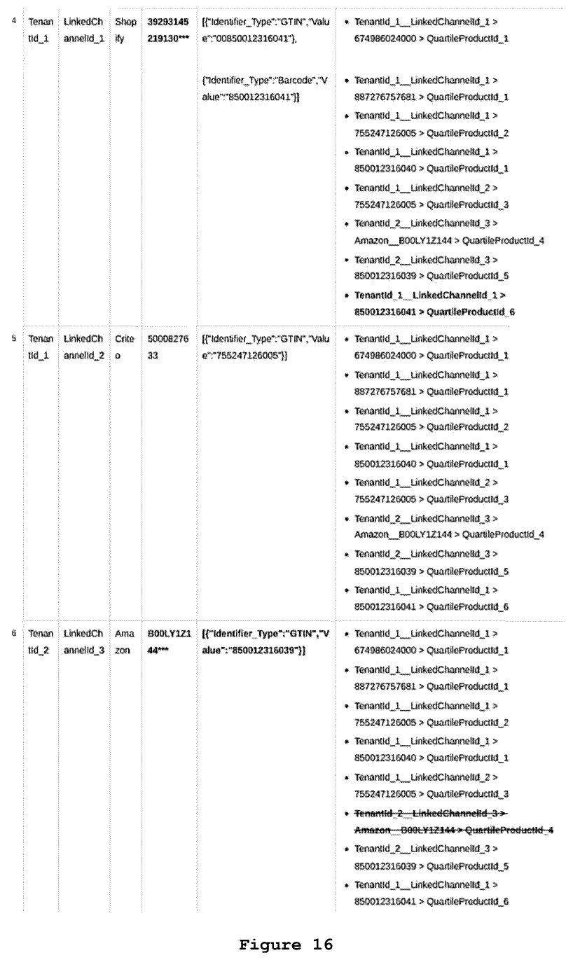

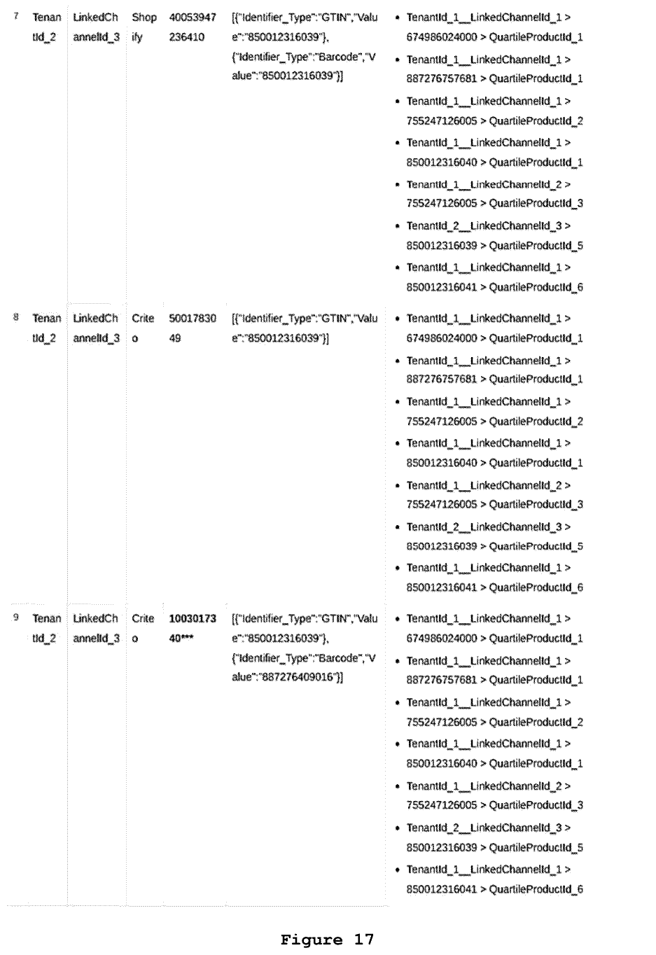

FIGS. 14-17 show the completely populated Table from FIGS. 11-13 after the system of the present invention substitutes the correct Global Identifier in place of the temporary Global Identifier previously generated by the system.

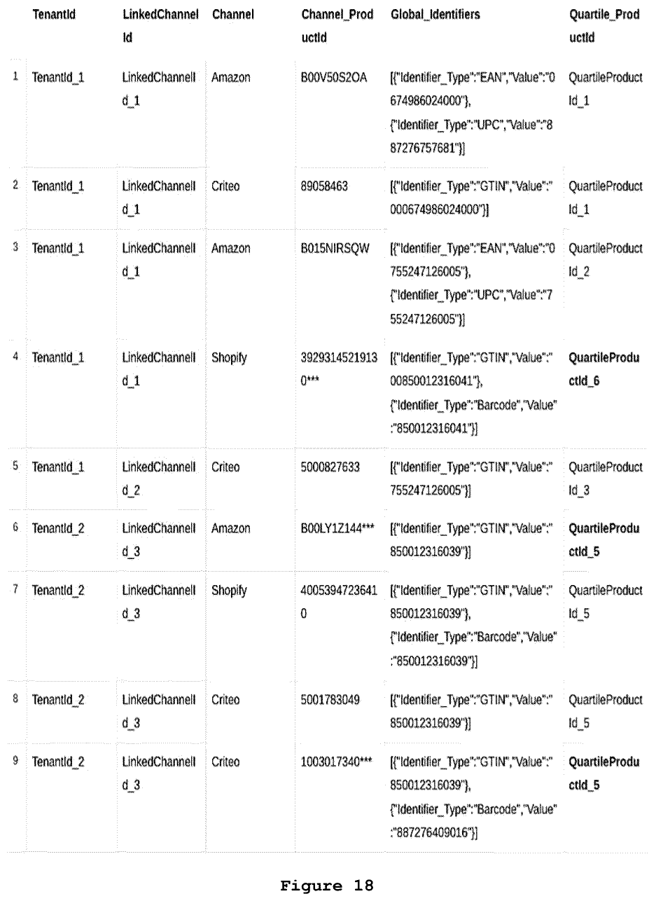

FIG. 18 shows an embodiment of the system's final mapping of the data shown in FIGS. 9-17. In this embodiment, the system is shown as having modified paired Global_Identifiers and Quartile_ProductIds, with the remapped Quartile_ProductIds in bold.

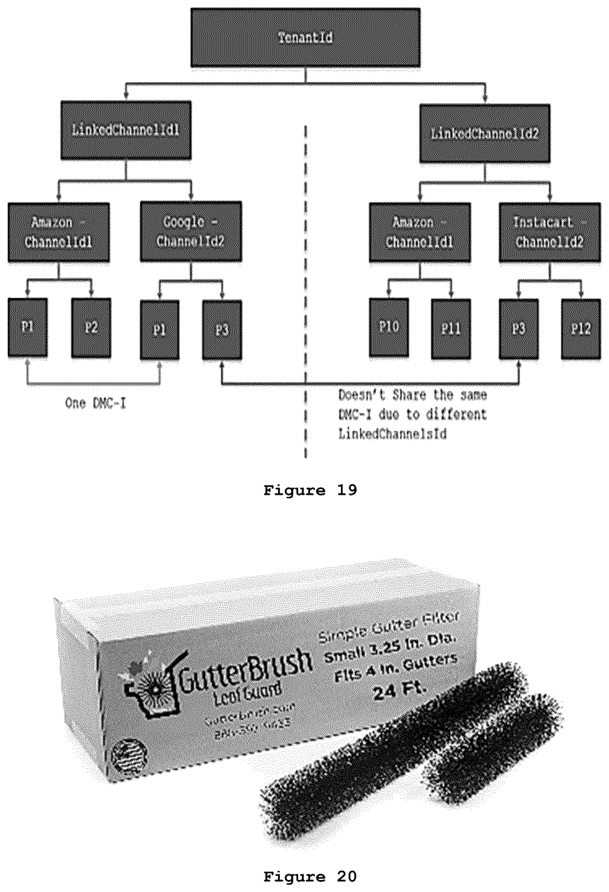

FIG. 19 shows a flowchart of how one TenantId may appear in the system of the present invention, with the Tenant ID having two LinkedChannelIds with products P1, P2, P3, P10, P11, and P12. In some embodiments, the same product P1 may have the same DMC-I even when being advertised in different channels, because the product P1 is listed under the same LinkedChannelId. Conversely, another product P3 may have two different DMC-I, despite being the same product under the same TenantId, because the product P3 is listed under two different LinkedChannelIds.

FIGS. 20 and 21 show depictions of products having commercial data that companies may seek to organize and analyze using the system of the present invention. FIG. 21 further shows a product which may be listed on a marketplace but which may have incomplete data for which the system may then create a temporary identifier.

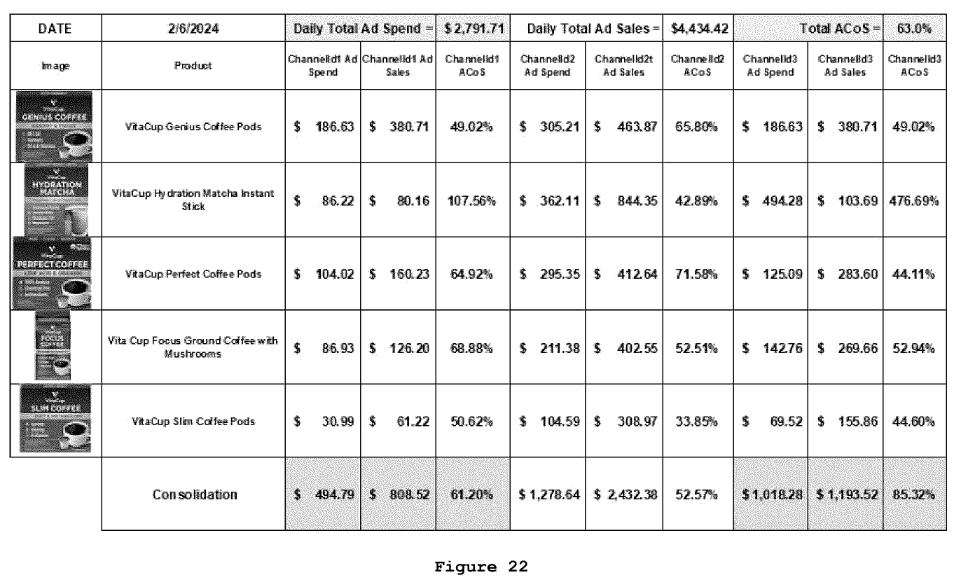

FIG. 22 shows a consolidation of the data retrieved for a group of products in three different marketplaces in a given week in one embodiment of the present invention. The consolidation makes it easy for the seller to understand where its marketing is effective and ineffective. To facilitate the analysis, the first line of the tables shows the Total Ad spend in that day, for the products on the three Marketplaces, the Total Ad Sales accordingly, and the ACoS for the day. In the embodiment shown in FIG. 22, a seller may easily understand that ChannelId3 is less efficient that ChannelId2 for this group of products, and that they should reallocate their marketing budget accordingly.

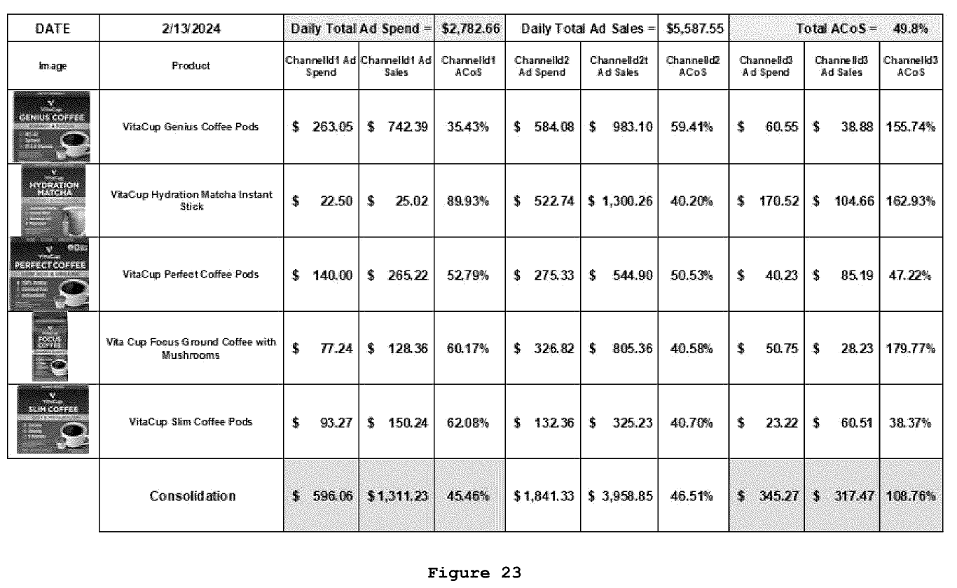

FIG. 23 shows the Consolidation of the same group of products exactly one week later when, taking into account the results consolidated in the Table of FIG. 22, the new distribution of the advertising budget was modified to reflect what was learned from the data one week earlier.

As can be seen, the Total advertising spend was almost the same, $2,791.76 on Feb. 6, 2024, and $2.782.66 on Feb. 13, 2024. Even spending almost the same amount on advertising, the distribution of this value was changed, reducing the amount spent on ChannelId1, and increasing the spend on the other two Channels.

The ratio used to reduce and increase these amounts was calculated using the DMCs' algorithms The changes proved successful, increasing Total Ad Sales by 26%, from $4,432.42 to $5,587.55, with the correspondent reduction on the ACoS from 63.0% to 49.8%, proving the effectiveness of the method of the present invention.

If desired, the redistribution of the Ad budget can be done at any time interval respecting the Channels' rules for retrieving the information. In a preferred embodiment of the present invention, this is done weekly, to allow for any punctual changes due to external undesired factors.

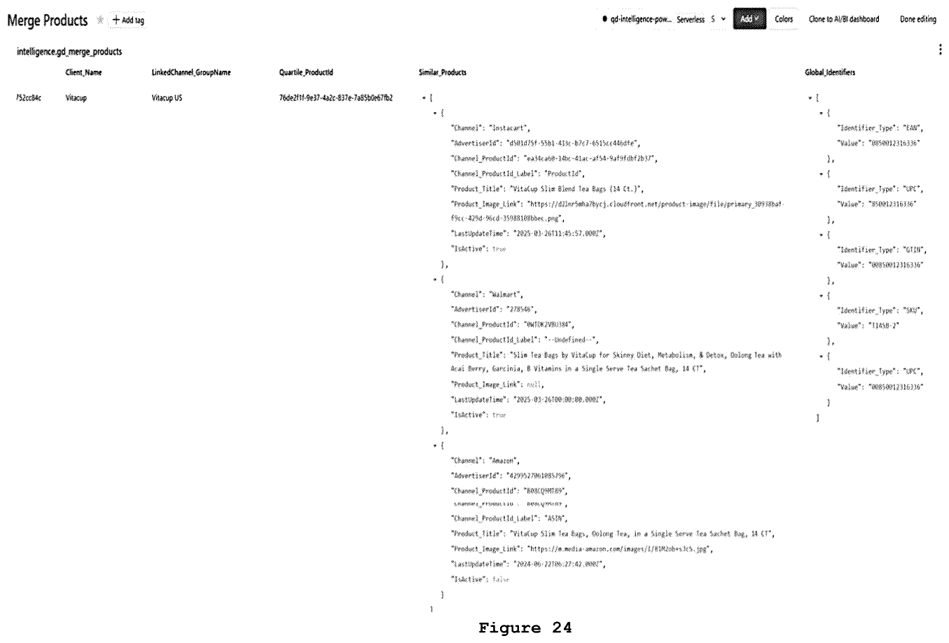

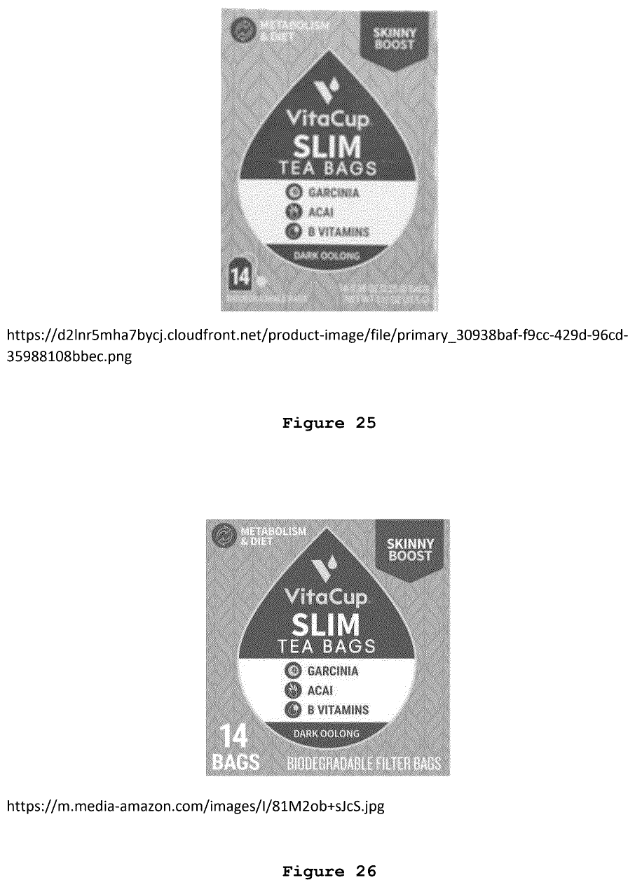

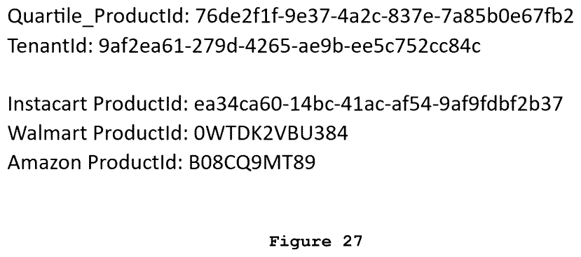

FIGS. 24 and 27 show identification parameters for an exemplary product illustrated in FIGS. 25 and 26, available on separate marketplaces, in connection with a preferred embodiment of the present invention, exemplifying the scope and applicability of the present invention, including by successfully consolidating commercial data for the product among several channels, e.g., INSTACART, WALMART, and AMAZON.

In some embodiments, features of the system of the present invention include an Updated Linked Accounts interface that allows users to link together multiple advertiser accounts across different channels, a New Linked Products interface that allows users to link together products across multiple channels as well as view products automatically identified and linked by the system of the present invention, a New Linked Products database that stores product identifiers across channels based on Linked Accounts and Linked Products interfaces, and a Cross-Channel Products report (e.g., sales, clicks, ad spending, etc.) using the Linked Products and Linked Accounts data generated by the system of the present invention.

The present invention solves the problem of how to consolidate commercial data associated with selling the same product across different channels by creating a single proprietary global identification label on the DMC's database for every advertised product under the DMC's management. These labels are associated to specific sellers and each channel where these sellers advertise their products, such that each product is stored under both each seller and each channel that originated the data. Thus, the stored data consolidates the commercial data for all the channels on which the seller advertises and sells that specific product.

The embodiments and examples above are illustrative, and many variations can be introduced to them without departing from the spirit of the disclosure. For example, elements and/or features of different illustrative and exemplary embodiments herein may be combined with each other and/or substituted with each other within the scope of this disclosure. For a better understanding of the invention, its operating advantages and the specific objects attained by its uses, reference should be had to the accompanying drawings and descriptive matter in which there are illustrated exemplary embodiments of the invention.

What is claimed is:

1. A method for linking product data from multiple channels of online marketplaces, the method comprising:
under control of one or more processors configured with executable instructions,
a) providing at least one first parameter associated with a product;
b) generating a primary table based on the at least one first parameter;
c) determining at least one first value associated with the at least one first parameter;
d) obtaining data associated with the product from multiple channels of online marketplaces;
e) transforming the data into a unified format, wherein the transformed data comprises at least one second value;
f) automatically generating an updated primary table based on the primary table, the at least one first value, and the transformed data comprising the at least one second value in an iterative or recursive manner; and
g) continuously replacing the primary table with the updated primary table in an iterative or recursive manner through repeating steps (d)-(f).

2. The method of claim 1, wherein the step of generating the updated primary table further comprises at least one of the followings steps:
matching the at least one first value to the at least one second value,
adding at least one second parameter to the primary table based on the at least one second value,
deleting the at least one first parameter from the primary table based on the at least one second value, or
modifying the at least one first parameter based on the at least one value of the transformed data.

3. The method of claim 1, wherein the step of obtaining data associated with the product comprises obtaining the data from the multiple channels of online marketplaces through an application programming interface call.

4. The method of claim 1, wherein the step of transforming the data into a unified format comprises transforming the data from an unprocessed state into an input table, with the input table comprising the at least one second value.

5. The method of claim 4, wherein each of the at least one first value and the at least one second value comprises at least one parameter type, the at least one parameter type comprising at least one of a product identifier, a product channel identifier, and a product activity indicator.

6. The method of claim 5, wherein the at least one parameter type includes a product identifier, and wherein the product identifier includes at least one of a channel product identifier, a product title, a product image, and a global identifier.

7. The method of claim 5, wherein the at least one parameter type includes a product identifier, and wherein the product identifier is at least one of a global trade item number (GTIN), an AMAZON standard identification number (ASIN), a universal product code (UPC), a European article number (EAN), an international standard book number (ISBN), a Japanese article number (JAN), a medical instrument standardized article number (MINSAN), and a stock keeping unit (SKU).

8. The method of claim 5, wherein the step of transforming the data from the unprocessed state into the input table comprises determining a parameter type of the data and assigning the determined parameter type to the at least one second value.

9. A system for linking product data from multiple channels of online marketplaces, the system comprising:
one or more processors;
one or more computer-readable media; and
one or more modules maintained on the one or more computer-readable media that, when executed by the one or more processors, cause the one or more processors to perform operations including:
a) providing at least one first parameter associated with a product;
b) generating a primary table based on the at least one first parameter;
c) determining at least one first value associated with the at least one first parameter;
d) obtaining data associated with the product from multiple channels of online marketplaces;
e) transforming the data into a unified format, wherein the transformed data comprises at least one second value;
f) automatically generating an updated primary table based on the primary table, the at least one first value, and the transformed data comprising the at least one second value in an iterative or recursive manner; and
g) continuously replacing the primary table with the updated primary table in an iterative or recursive manner through repeating steps (d)-(f).

10. The system of claim 9, wherein the updated primary table is generated by at least one of:
matching the at least one first value to the at least one second value,
adding at least one second parameter to the primary table based on the at least one second value,
deleting the at least one first parameter from the primary table based on the at least one second value, or
modifying the at least one first parameter based on the at least one value of the transformed data.

11. The system of claim 9, wherein the data associated with the product is obtained from the multiple channels of online marketplaces through an application programming interface call.

12. The system of claim 9, wherein the data is transformed into a unified format by transforming the data from an unprocessed state into an input table, with the input table comprising the at least one second value.

13. The system of claim 12, wherein each of the at least one first value and the at least one second value comprises at least one parameter type, the at least one parameter type comprising at least one of a product identifier, a product channel identifier, and a product activity indicator.

14. The system of claim 13, wherein the at least one parameter type includes a product identifier, and wherein the product identifier includes at least one of a channel product identifier, a product title, a product image, and a global identifier.

15. The system of claim 13, wherein the at least one parameter type includes a product identifier, and wherein the product identifier is at least one of a global trade item number (GTIN), an AMAZON standard identification number (ASIN), a universal product code (UPC), a European article number (EAN), an international standard book number (ISBN), a Japanese article number (JAN), a medical instrument standardized article number (MINSAN), and a stock keeping unit (SKU).

16. The system of claim 13, wherein the step of transforming the data from the unprocessed state into the input table comprises determining a parameter type of the data and assigning the determined parameter type to the at least one second value.

17. A method for linking product data from multiple channels of online marketplaces, the method comprising:
under control of one or more processors configured with executable instructions,
a) providing a plurality of parameters associated with at least one product, the plurality of parameters including at least one product identifier and at least one client identifier;
b) generating a primary table based on the plurality of parameters;
c) mapping the plurality of parameters based on the primary table, such that each at least one product identifier is associated with at least one client identifier;
d) determining at least one first value associated with each of the plurality of parameters;
e) obtaining raw data associated with the product from multiple channels of online marketplaces;
f) transforming the raw data into an input table, wherein the input table comprises at least one second value;
g) automatically generating an updated primary table based on the primary table and the input table in an iterative or recursive manner by:
1) comparing the at least one second value with the at least one first value;
2) determining whether the at least one second value supersedes the at least one first value;
3) discarding the at least one second value when the at least one second value matches the at least one first value;
4) replacing the at least one first value with the at least one second value when the at least one second value is determined to supersede the at least one first value; and
5) appending the at least one second value to the primary table when the at least one second value does not match or supersede the at least one first value; and
h) continuously replacing the primary table with the updated primary table in an iterative or recursive manner through repeating steps (e)-(g).

18. The method of claim 17, wherein the step of transforming the raw data into an input table includes normalizing the data into the at least one second value.
